(19) United States
(12) Patent Application Publication
(10) Pub. No.: US 2010/0095382 A1
(43) Pub. Date: Apr. 15, 2010

(54) Real Invention

(76) Inventor: Theodoros H. Asimakopoulos, Silver Spring, MD (US)

Correspondence Address: Theodoros Asimakopoulos, 3705 Jeffry St., Silver Spring, MD, 20906, US

(21) Appl. No.: 12/456,810

(22) Filed: Jun. 23, 2009

Related U.S. Application Data
(60) Provisional application No. 61/075,717, filed on Jun. 25, 2008.

(51) Int. Cl. G06F 21/24

(52) U.S. Cl. 726/26

(57) ABSTRACT

For this patent there is blocking of illegal theft sites at the search engine website address. Regularly updated theft sites are blocked and the website address search engine is updated with new program. Also covered under this patent although don't know if every claim is used or a few, is tagging of files (songs, movies, etc.). What this is, is every song downloaded on the internet comes with a tag and when synced to audio of movie device, if the song or movie is not tagged or certified not to be from a theft site than the song is not allowed on the sync page. Also covered (although don't know if going to be used) is the device whether it be a ipod, itv or something else, the device recognizes a tagged or untagged music, movie, etc. file. Don't know if this is going to be used. There is either universal tag or a tag strictly for one such device. For example just itunes songs for ipod.

For this patent there is blocking of illegal theft sites at the search engine website address. Regularly updated theft sites are blocked and the website address search engine is updated with new program. Also covered under this patent although don't know if every claim is used or a few, is tagging of files (songs, movies, etc.). What this is, is every song downloaded on the internet comes with a tag and when synced to audio of movie device, if the song or movie is not tagged or certified not to be from a theft site than the song is not allowed on the sync page. Also covered (although don't know if going to be used) is the device whether it be a ipod, itv or something else, the device recognizes a tagged or untagged music, movie, etc. file. Don't know if this is going to be used. There is either universal tag or a tag strictly for one such device. For example just itunes songs for ipod.

### BACKGROUND OF THE INVENTION

In the past there has been much theft of music and movies on the internet. Now with anti theft invention the problem does not exist any more. One can gain knowledge of this by reading abstract and specification.

### BRIEF SUMMARY OF THE INVENTION

For this patent there is blocking of illegal theft sites at the search engine website address. Regularly updated theft sites are blocked and the website address search engine is updated with new program. Also covered under this patent although don't know if every claim is used or a few, is tagging of files (songs, movies, etc.). What this is, is every song downloaded on the internet comes with a tag and when synced to audio of movie device, if the song or movie is not tagged or certified not to be from a theft site than the song is not allowed on the sync page. Also covered (although don't know if going to be used) is the device whether it be a ipod, itv or something else, the device recognizes a tagged or untagged music, movie, etc. file. Don't know if this is going to be used. There is either universal tag or a tag strictly for one such device. For example just itunes songs for ipod.

### DETAILED DESCRIPTION OF THE INVENTION

For this patent there is blocking of illegal theft sites at the search engine website address. Regularly updated theft sites are blocked and the website address search engine is updated with new program. Also covered under this patent although don't know if every claim is used or a few, is tagging of files (songs, movies, etc.). What this is, is every song downloaded on the internet comes with a tag and when synced to audio of movie device, if the song or movie is not tagged or certified not to be from a theft site than the song is not allowed on the sync page. Also covered(although don't know if going to be used) is the device whether it be a ipod, itv or something else, the device recognizes a tagged or untagged music, movie, etc. file. Don't know if this is going to be used. There is either universal tag or a tag strictly for one such device. For example just itunes songs for ipod.

1. Blocking of illegal theft sites of music and movies by having them blocked at website address.

2. Every search engine for the world wide web has blocked sites that are recognized and are blocked and the illegal theft sites are updated regularly.

3. Every search engine comes installed with the blocking and updates of illegal thefts.

4. Every song or movie downloaded on the internet comes with a tag and when synced to audio or movie device if the song or movie is not tagged or certified not to be from a theft site than the song is not allowed on the sync page.

5. Every song or movie downloaded on the internet comes with a tag and when synced to audio or movie device if the song or movie is not tagged or certified not to be from a theft site than the song is not allowed on the mp3 player, itv, ipod, etc. because the device is programmed to tell whether or not the song, movie, etc. is defective.

6. There is a either universal tag or a tag strictly for one such device. Example just itunes songs for ipod.
